(19) United States
(12) Patent Application Publication
(10) Pub. No.: US 2024/0202929 A1
(43) Pub. Date: Jun. 20, 2024

(54) IMAGE CROPPING AND PROCESSING METHOD FOR ADJUSTING ASPECT RATIO, ELECTRONIC DEVICE, TERMINAL DEVICE IN COMMUNICATION WITH THE ELECTRONIC DEVICE, AND NON-TRANSITORY COMPUTER-READABLE RECORDING MEDIUM

(71) Applicant: COMPAL ELECTRONICS, INC., Taipei (TW)

(72) Inventors: PIN-YU CHOU, Taipei (TW); HUI-MEI HUNG, Taipei (TW); YUEH-HUA LEE, Taipei (TW); HAO-HSIN LO, Taipei (TW)

(21) Appl. No.: 18/537,843

(22) Filed: Dec. 13, 2023

Related U.S. Application Data
(60) Provisional application No. 63/433,017, filed on Dec. 16, 2022.

(51) Int. Cl. G06T 7/12; G06T 3/40; G06T 7/62

(52) U.S. Cl. CPC G06T 7/12; G06T 3/40; G06T 7/62; G06T 2207/20132; G06T 2207/30201; G06T 2207/30242

(57) ABSTRACT

An image cropping and processing method for adjusting an aspect ratio involves identifying coordinates of the human being in the initial image to define a human body coverage area and a first focal coordinate. The, using the first focal coordinate as a center point to define a cropping frame having a second aspect ratio, and the cropping frame corresponds to the human body coverage area and is enlarged according to a ratio parameter. The coordinates of a face of the human being in the initial image are identified to define a facial coverage area a second focal coordinate. The center point of the cropping frame is moved from a third focal coordinate thereof to coincide with the second focal coordinate, and when it is judged that the cropping frame is covered within the initial image, the cropping frame is selected as a cropped final image.

### CROSS-REFERENCE TO RELATED APPLICATION

This non-provisional application claims priority under 35 U.S.C. § 119(e) on U.S. provisional Patent Application No. 63/433,017 filed on Dec. 16, 2022, the entire contents of which are hereby incorporated by reference.

### BACKGROUND OF THE INVENTION

### 1. Field of the Invention

The present disclosure relates to an image cropping technology, and in particular to an image cropping and processing method for adjusting an aspect ratio, an electronic device, a terminal device in communication with the electronic device, and a non-transitory computer-readable recording medium.

### 2. Description of the Related Art

Conventional child monitoring systems capture images by a photographic device and can be selected by artificial intelligence. However a common problem is that the proportion of characters in the image with the original aspect ratio is too small, and/or the position of the characters in the images is too marginal, even though the bodies and expressions of characters present content worth collecting, they have a great chance to be eliminated during selection because the proportion and/or position of the characters in the initial image is not satisfactory. Even if manually selected, if the image is not processed artificially, the proportion and position of the characters in the image with the original aspect ratio will not meet the expectations of users.

Therefore, it is an objective of the present disclosure to overcome the problem of unsatisfactory composition caused by traditional image processing that is performed by artificial intelligence.

### BRIEF SUMMARY OF THE INVENTION

The present invention provides an image cropping and processing method for adjusting an aspect ratio, an electronic device, a terminal device in communication with the electronic device, and a non-transitory computer-readable recording medium, which can adjust the proportion and/or position of the characters in the initial image, so that a satisfactory cropped image is produced.

In order to achieve the above objective and more, the present disclosure provides an image cropping and processing method for adjusting an aspect ratio, which is executed by an electronic device reading an executable code. When a human being is identified in an initial image by artificial intelligence, cropping to the initial image from a first aspect ratio is executed to crop a cropped image that meets a second aspect ratio. The method includes the following steps: calculating a human body coverage area: identifying coordinates of the human being in the initial image to define a human body coverage area, and defining a center point of the human body coverage area as a first focal coordinate; calculating a cropping ratio: using the first focal coordinate as a center point to define a cropping frame, the cropping frame has the second aspect ratio, and the cropping frame corresponds to the human body coverage area and is enlarged according to a ratio parameter; calculating a facial coverage area: identifying coordinates of a face of the human being in the initial image to define a facial coverage area, and defining a second focal coordinate of a center point of the facial coverage area; and alignment cropping: defining a center point of the cropping frame as a third focal coordinate, moving the center point of the cropping frame from the third focal coordinate to coincide with the second focal coordinate, and when it is judged that the cropping frame is covered within the initial image, an image of the cropping frame is selected as the cropped final image.

In an embodiment, the ratio parameter in the step of calculating a cropping ratio is determined by successively conforming to a covering ratio and a difference ratio, wherein the covering ratio is defined as when the center point of the cropping frame is moved from the third focal coordinate to coincide with the second focus coordinate, a ratio that the human body coverage area is covered by the cropping frame without exceeding is taken; the definition of the difference ratio is to take a ratio that an area difference between the human body coverage area and the cropping frame is smallest according to a setting ratio range.

In an embodiment, the ratio range is set between 40% and 80% of the original size.

In an embodiment, in the step of calculating a cropping ratio, if the cropping frame exceeds a vertical boundary and/or horizontal boundary of the original size, the cropping frame shifts back according to the exceeded vertical boundary and/or horizontal boundary.

In an embodiment, in the step of alignment and cropping, if the center point of the cropping frame is moved from the third focal coordinate to coincide with the second focus coordinate, and the cropping frame exceeds the vertical boundary or horizontal boundary of the original size, the cropping frame shifts back according to the exceeded vertical boundary and/or horizontal boundary, so as to meet the condition that the cropping frame is covered within the initial image.

In an embodiment, when there are two or more human beings in the initial image, in the step of calculating a human body coverage area, a first upper boundary coordinate and a first lower boundary coordinate of each human being are identified, in which a first maximum vertical ordinate value and a first minimum horizontal ordinate value are taken to define a human body collection upper boundary coordinate, and a first minimum vertical ordinate value and a first maximum horizontal ordinate value are taken to define a human body collection lower boundary coordinate, the human body collection upper boundary coordinate and the human body collection lower boundary coordinate are used to define the human body coverage area.

In an embodiment, when there are two or more human beings in the initial image, in the step of calculating a facial coverage area, a second upper boundary coordinate and a second lower boundary coordinate of a face of each human being are identified, in which a second maximum vertical ordinate value and a second minimum horizontal ordinate value are taken to define a face collection upper boundary coordinate, and a second minimum vertical ordinate value and a second maximum horizontal ordinate value are taken to define a face collection lower boundary coordinate, the face collection upper boundary coordinate and the face collection lower boundary coordinate are used to define the facial coverage area.

The present disclosure further provides an electronic device of image cropping for adjusting an aspect ratio, which is provided in communication with a database. The database receives an initial image and identifies a human being by artificial intelligence and is used to execute cropping to the initial image from a first aspect ratio to crop a cropped final image that meets a second aspect ratio. The electronic device includes: a photography unit, for taking the initial image; and a processing unit, electrically connected to the photographic unit. The processing unit includes: a human body coverage area calculation module, for identifying coordinates of the human being in the initial image to define a human body coverage area, and defining a center point of the human body coverage area as a first focal coordinate; a cropping ratio calculation module, electrically connected to the human body coverage area calculation module, using the first focal coordinate as a center point to define a cropping frame, the cropping frame has the second aspect ratio, and the cropping frame corresponds to the human body coverage area and is enlarged according to a ratio parameter; a facial coverage area calculating module, for identifying coordinates of a face of the human being in the initial image to define a facial coverage area, and defining a second focal coordinate of a center point of the facial coverage area; and an alignment and cropping module, electrically connected to the cropping ratio calculation module and the facial coverage area calculation module, for defining a center point of the cropping frame as a third focal coordinate, moving the center point of the cropping frame from the third focal coordinate to coincide with the second focal coordinate, and when it is judged that the cropping frame is covered within the initial image, an image of the cropping frame is selected as the cropped final image.

The present disclosure further provides a terminal device in communication with the electronic device. The terminal device is equipped with an application program and the terminal device executes the application program to display the cropped final image.

In an embodiment, the electronic device is a physical host and/or a cloud host.

The present disclosure also provides a non-transitory computer-readable recording medium, storing a plurality of executable codes, after reading the executable codes and executing, an electronic device can execute the above-described image cropping and processing method to intelligently identify a plurality of preset objects, and multimedia image processing is performed for the plurality of preset objects.

Accordingly, the composition of the cropped image obtained by the image cropping and processing method and electronic device of the present disclosure is centered on the faces of characters in the image, and the characters in the initial image are recomposed according to the second aspect ratio of the cropping frame, which ensures that the cropped final image conforms to the composition effect of the characters as the main body.

Further, the image cropping and processing method and the electronic device of the present disclosure may be executed to shift the cropping frame back according to the exceeded vertical boundary and/or horizontal boundary, at this time, it can still obtain the composition effect that makes the cropped final image closer to the characters as the main body than the initial image.

### BRIEF DESCRIPTION OF THE DRAWINGS

FIG. 1 is a flow chart of main steps of an image cropping and processing method for adjusting aspect ratio according to an embodiment of the present disclosure.

FIG. 2 is a block diagram of an electronic device and a terminal device in communication with the electronic device according to an embodiment of the present disclosure.

FIG. 3 is a flow chart illustrating the steps of an image cropping and processing method for adjusting aspect ratio according to an embodiment of the present disclosure.

FIG. 4 is a flow chart illustrating the process A of FIG. 3 according to an embodiment of the present disclosure.

FIG. 5 is a flow chart illustrating the process B of FIG. 3 according to an embodiment of the present disclosure.

FIG. 6 is a flow chart illustrating the process C of FIG. 3 according to an embodiment of the present disclosure.

FIG. 7 is a flow chart illustrating the process D of FIG. 3 according to an embodiment of the present disclosure.

FIG. 8A is a diagram illustrating a method of cropping according to an embodiment of the present disclosure.

FIG. 8B is a diagram illustrating a method of cropping according to an embodiment of the present disclosure.

FIG. 8C is a diagram illustrating a method of cropping according to an embodiment of the present disclosure.

FIG. 8D is a diagram illustrating a method of cropping according to an embodiment of the present disclosure.

FIG. 8E is a diagram illustrating a method of cropping according to an embodiment of the present disclosure.

FIG. 9A is an enlarged detailed view illustrating defining a human body coverage area of FIG. 8A according to an embodiment of the present invention.

FIG. 9B is an enlarged detailed view illustrating defining a facial coverage area of FIG. 8C according to an embodiment of the present invention.

FIG. 10A is a diagram illustrating a method of cropping according to an embodiment of the present disclosure.

FIG. 10B is a diagram illustrating a method of cropping according to an embodiment of the present disclosure.

FIG. 10C is a diagram illustrating a method of cropping according to an embodiment of the present disclosure.

FIG. 10D is a diagram illustrating a method of cropping according to an embodiment of the present disclosure.

FIG. 10E is a diagram illustrating a method of cropping according to an embodiment of the present disclosure.

FIG. 10F is a diagram illustrating a method of cropping according to an embodiment of the present disclosure.

FIG. 11A is a diagram illustrating a method of cropping according to an embodiment of the present disclosure.

FIG. 11B is a diagram illustrating a method of cropping according to an embodiment of the present disclosure.

FIG. 11C is a diagram illustrating a method of cropping according to an embodiment of the present disclosure.

FIG. 11D is a diagram illustrating a method of cropping according to an embodiment of the present disclosure.

FIG. 11E is a diagram illustrating a method of cropping according to an embodiment of the present disclosure.

FIG. 11F is a diagram illustrating a method of cropping according to an embodiment of the present disclosure.

FIG. 12A is a drawing illustrating a method of cropping according to an embodiment of the present disclosure.

FIG. 12B is a drawing illustrating a method of cropping according to an embodiment of the present disclosure.

FIG. 12C is a drawing illustrating a method of cropping according to an embodiment of the present disclosure.

FIG. 12D is a drawing illustrating a method of cropping according to an embodiment of the present disclosure.

FIG. 13A is a drawing illustrating a method of cropping according to an embodiment of the present disclosure.

FIG. 13B is a drawing illustrating a method of cropping according to an embodiment of the present disclosure.

FIG. 13C is a drawing illustrating a method of cropping according to an embodiment of the present disclosure.

### DETAILED DESCRIPTION OF THE INVENTION

To facilitate understanding of the objectives, characteristics, and effects of the present disclosure, specific embodiments together with the attached drawings for the detailed description of the present disclosure are provided as below.

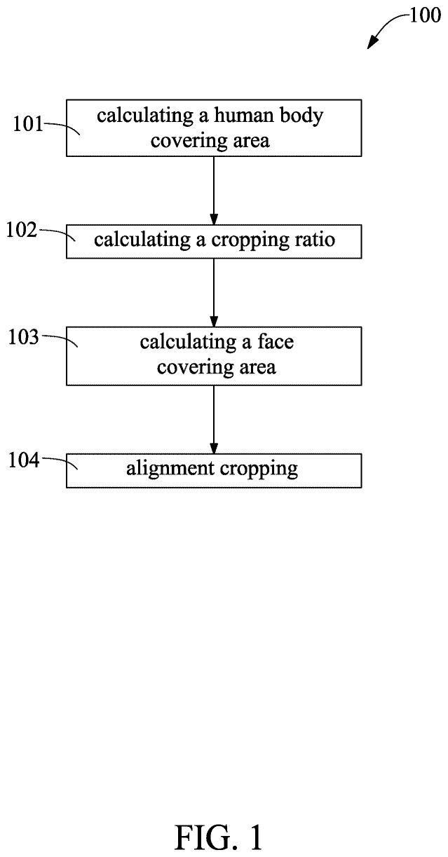

Referring to FIGS. 1 to 13C, the present disclosure provides an image cropping and processing method 100 for adjusting an aspect ratio, an electronic device 200, a terminal device 300 in communication with the electronic device 200, and a non-transitory computer-readable recording medium.

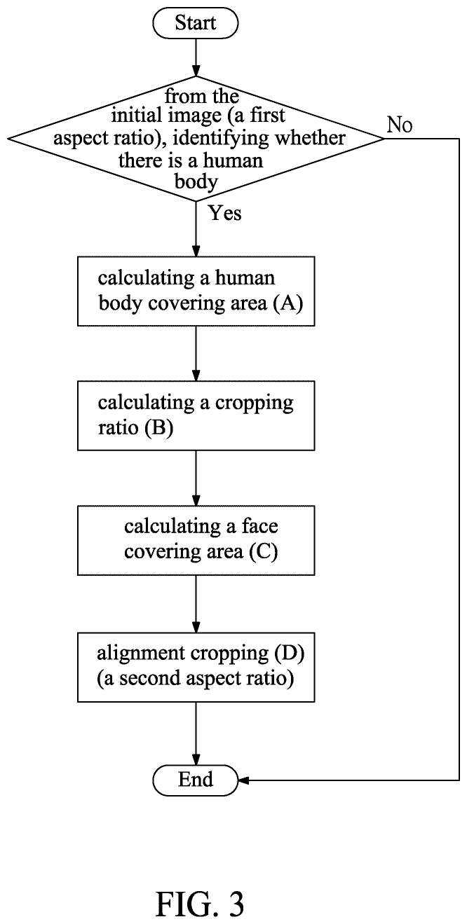

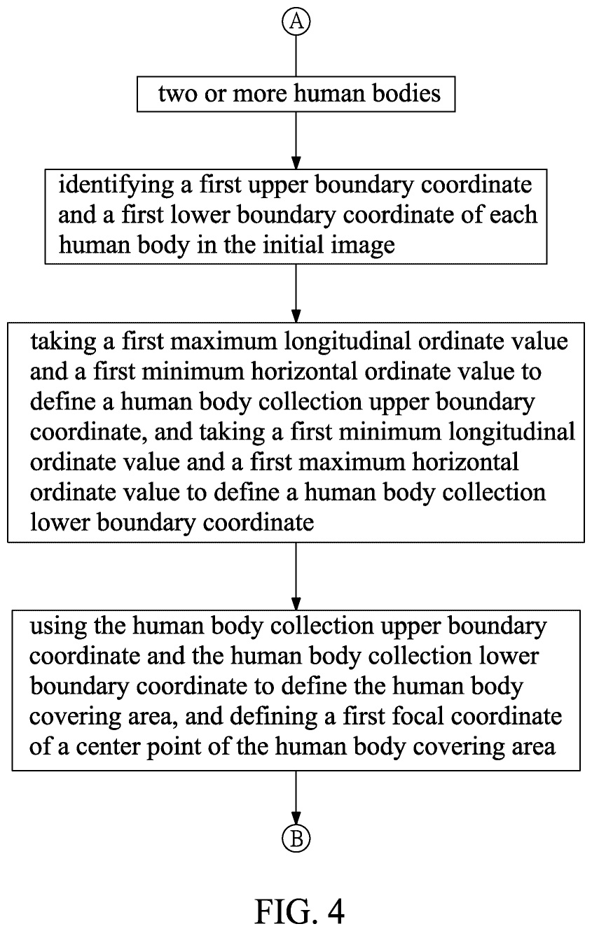

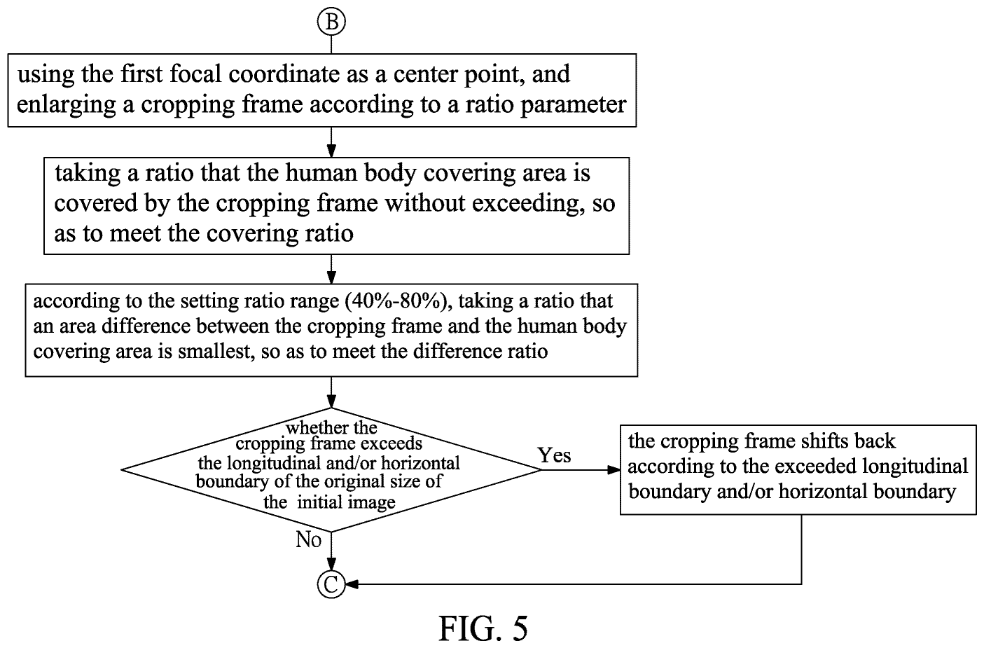

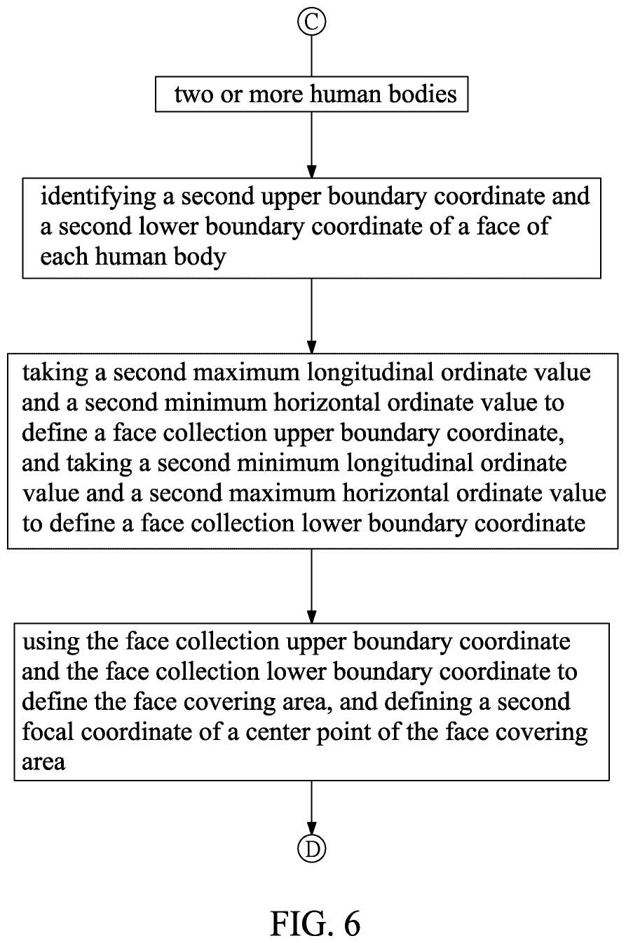

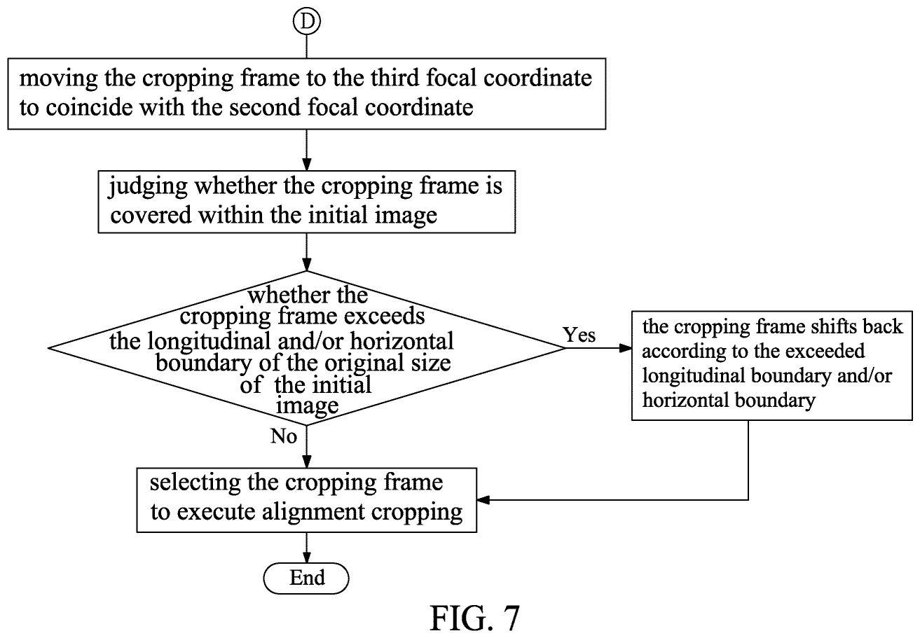

The image cropping and processing method 100 is executed by the electronic device 200 reading an executable code, and using artificial intelligence to identify whether there is a human body in an initial image V1. When there is a human body (one or more human bodies) detected, the steps of calculating a human body coverage area 101 (and marking process A in FIG. 3 and detailed in FIG. 4), calculating a cropping ratio 102 (and marking process B in FIG. 3 and detailed in FIG. 5), calculating a facial coverage area 103 (and marking process C in FIG. 3 and detailed in FIG. 6), and alignment and cropping 104 (and marking process D in FIG. 3 and detailed in FIG. 7) as shown in FIG. 1 are executed, in order to execute cropping of the initial image V1 from a first aspect ratio to crop a cropped final image V2 that meets a second aspect ratio. A plurality of executable codes executed by the image cropping and processing method 100 may be stored in a non-transitory computer-readable recording medium, so that the electronic device 200 can execute the code after reading the plurality of executable codes from the non-transitory computer-readable recording medium.

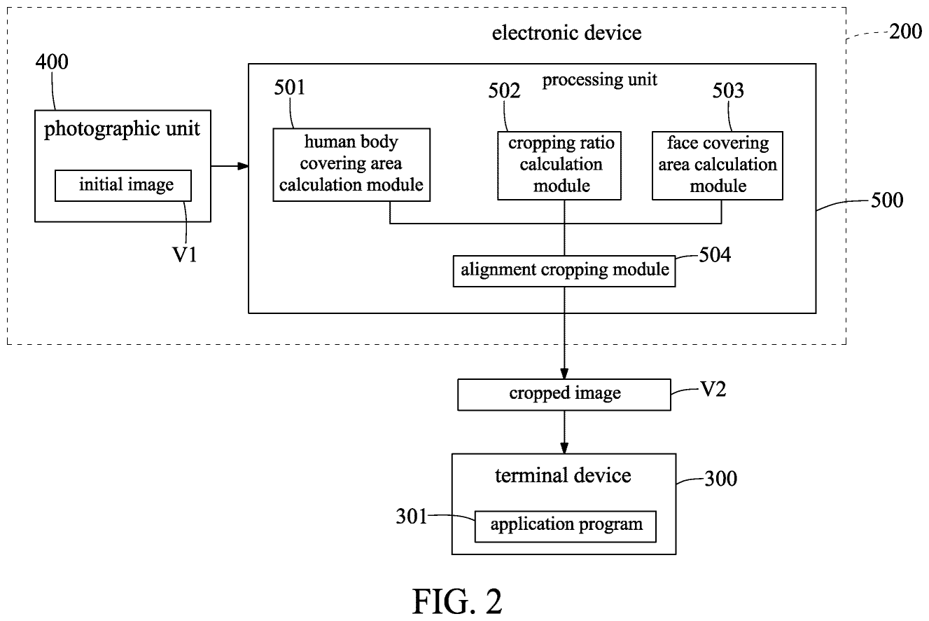

First, the electronic device 200 that executes the image cropping and processing method 100 will be described. In an embodiment, as shown in FIG. 2, the electronic device 200 includes a photography unit 400 and a processing unit 500. The photography unit 400 is electrically connected to the processing unit 500. The processing unit 500 includes a human body coverage area calculation module 501, a cropping ratio calculation module 502, a face coverage area calculation module 503, and an alignment and cropping module 504. The human body coverage area calculation module 501 is used to execute the step of calculating a human body coverage area 101. The cropping ratio calculation module 502 is used to execute the step of calculating a cropping ratio 102. The face coverage area calculation module 503 is used to execute the step of calculating a face coverage area 103. The alignment and cropping module 504 is used to execute the step of alignment and cropping 104. The method 100 processes the initial image V1 having the first aspect ratio to be cropped to a cropped final image V2 having the second aspect ratio. The first aspect ratio is, for example, 4:3 and the second aspect ratio is, for example, 16:9, but the present disclosure is not limited to the aspect ratio of this embodiment.

The electronic device 200 is a physical host and the electrically connected photography unit 400 is disposed in the same body, but the present disclosure is not limited thereto. The electronic device 200 may also be a cloud host, or a combination of a physical host and a cloud host. The initial image V1 may be stored in a database (not shown in the figure), the database may be stored on a cloud server, or the database may also be stored on a local server. By the electronic device 200 in communication with the database, the cropped final image V2 completed after the electronic device 200 executing the image cropping and processing method 100 is transmitted to the database and received and stored.

The present disclosure further provides a terminal device 300, which may be in communication with the electronic device 200, the terminal device 300 is equipped with an application program 301 (referring to FIG. 2 together). The terminal device 300 may be a portable mobile communication device, a tablet computer, a laptop computer, etc. that can be connected to the electronic device 200 via the Internet. By the terminal device 300 executing the application program 301, the user can receive the cropped final image V2 and display it via the terminal device 300.

When executing the image cropping and processing method 100, the step of calculating a human body coverage area 101 is to identify coordinates of the human body in the initial image V1 to define a human body coverage area A1. For example, when there are two or more human beings in the initial image V1, in the step of calculating a human body coverage area 101, a first upper boundary coordinate and a first lower boundary coordinate of each human being are identified, and a first maximum vertical ordinate value and a first minimum horizontal ordinate value are taken to define a human body collection upper boundary coordinate, and a first minimum vertical ordinate value and a first maximum horizontal ordinate value are taken to define a human body collection lower boundary coordinate. The human body collection upper boundary coordinate and the human body collection lower boundary coordinate are used to define the human body coverage area A1, and define a center point C1 of the human body coverage area A1 as a first focal point coordinate.

When the number of human beings in the initial image V1 is determined to be a single individual, a first upper boundary coordinate and a first lower boundary coordinate of the human body are identified, which is sufficient to define the human body coverage area A1 for covering the human body, and define the first focal coordinate of the center point C1 of the human body coverage area A1. In an embodiment the initial image V1 is 2592×1944 pixels, which meets an aspect ratio of 4:3, and the cropping ratio described in some of the following embodiments is compared to 100% of this size.

After the step of calculating a human body coverage area 101 is executed, the step of calculating a cropping ratio 102 is executed. The execution of calculating a cropping ratio 102 is to use the first focal coordinate as a center point to define a cropping frame A2, the cropping frame A2 has the second aspect ratio, and the cropping frame A2 corresponds to the human body coverage area A1 and is enlarged according to a ratio parameter. In other words, an area of the cropping frame A2 is larger than the human body coverage area A1, and the larger the human body coverage area A1 is, the larger the cropping frame A2 is, and vice versa.

After the step of calculating a cropping ratio 102 is executed, the step of calculating a face coverage area 103 is executed. The execution of calculating a face coverage area 103 is to identify coordinates of a face of a human being in the initial image V1 to define a face coverage area A3. For example, when there are two or more human beings in the initial image V1, a second upper boundary coordinate and a second lower boundary coordinate of the face of each human being are identified, and a second maximum vertical ordinate value and a second minimum horizontal ordinate value are taken to define a face collection upper boundary coordinate, and a second minimum vertical ordinate value and a second maximum horizontal ordinate value are taken to define a face collection lower boundary coordinate. The face collection upper boundary coordinate and the face collection lower boundary coordinate are used to define the face coverage area A3, and define a second focal coordinate of a center point C2 of the face coverage area A3.

When the number of human beings in the initial image V1 is one, a second upper boundary coordinate and a second lower boundary coordinate of the face of the human being are identified, which is sufficient to define the face coverage area A3 for covering the human body, and define a second focal coordinate of the center point C2 of the face coverage area A3.

After the step of calculating a face coverage area 103 is executed, the step of alignment and cropping 104 is executed. The execution of the step of alignment and cropping 104 is to define a center point of the cropping frame as a third focal coordinate, move the center point C3 of the cropping frame A2 from the third focal coordinate to coincide with the second focal coordinate, and when it is judged that the cropping frame A2 is covered within the initial image V1, the cropping frame A2 is selected as a cropped image V2.

In an embodiment, the ratio parameter is determined by successively conforming to a covering ratio and a difference ratio, wherein the covering ratio is defined as when the center point of the cropping frame A2 is moved from the third focal coordinate to coincide with the second focus coordinate, a ratio that the human body coverage area A1 is covered by the cropping frame A2 without exceeding is taken, so as to confirm that the human body coverage area A1 does not exceed the cropping frame A2 outside. For example, assuming that the human body coverage area A1 is calculated to be 38% of the initial image V1, then the cropping frame A2 in a certain proportion greater than 38% to less than 100% is in line with the covering ratio.

The definition of the difference ratio is to take a ratio that an area difference between the human body coverage area A1 and the cropping frame A2 is smallest according to a setting ratio range. In an embodiment, the ratio range is set to a minimum of 40% and a maximum of 80% according to the original size of the initial image V1 (2592×1944 pixels as described above), and a cropping frame A2 with an aspect ratio of 16:9 is produced according to the setting ratio range. Following the example in the preceding paragraph, the human body coverage area A1 is 38% of the initial image V1 after calculation, and those that meet the covering ratio are such as 40%, 50%, 60%, 70% and 80% according to the setting of the ratio range, and among these ratios, 40% is taken as a ratio that the difference with the human body coverage area A1 of 38% is smallest, and meets the difference ratio. Further, for example, the human body coverage area A1 is 69% of the initial image V1 after calculation, and 70% is taken as a ratio that meets the difference ratio, and the calculation of the covering ratio and the difference ratio is performed and so on.

For the above implementation, the embodiments are described below.

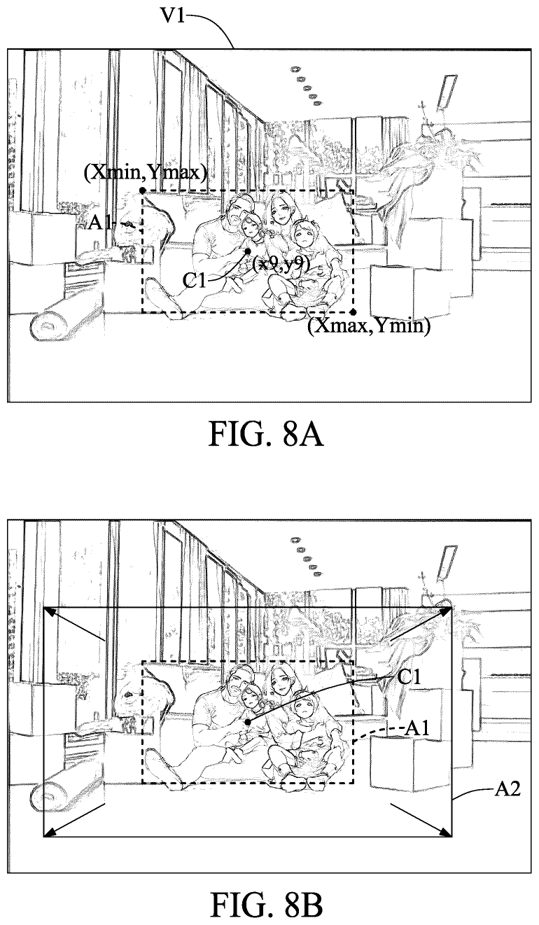

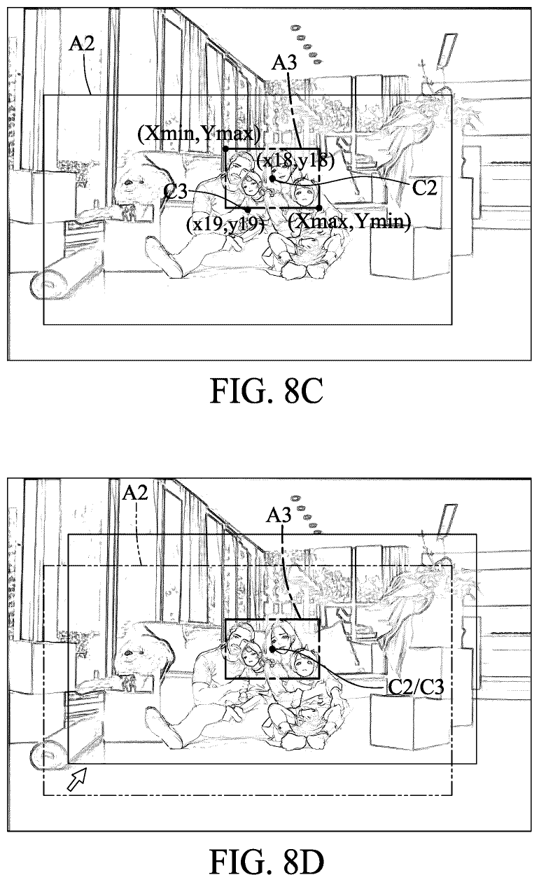

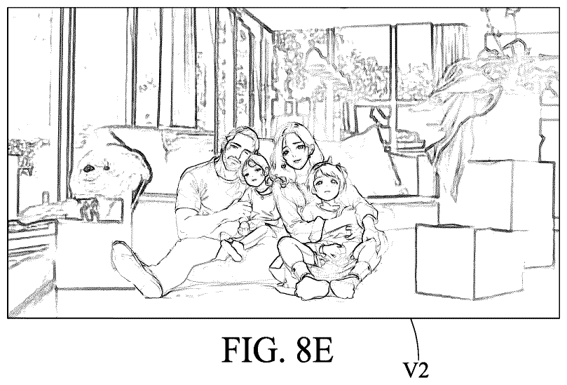

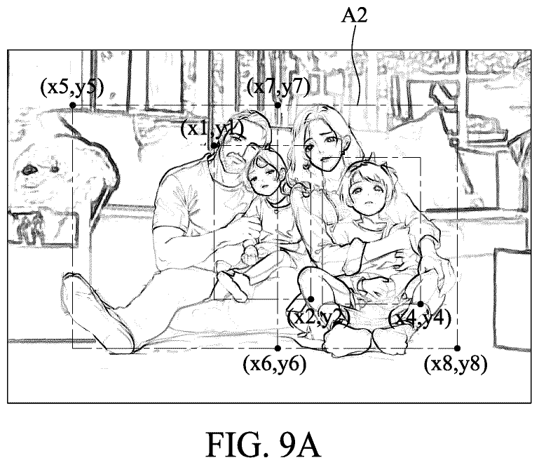

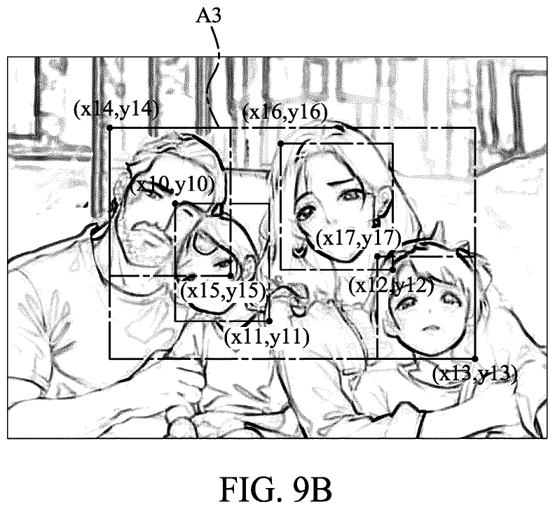

For example, FIGS. 8A to 9B are embodiments of the present invention. The scene of the initial image V1 as shown in FIG. 8A includes two child human beings and two adult human beings, wherein the adults and children are seated and located in the center of the initial image V1. Referring to the process A shown in FIG. 4 together, by executing the step of calculating a human body coverage area 101, there are the two child human beings and two adult human beings identified by artificial intelligence. Referring to FIG. 9A together, a first upper boundary coordinate and a first lower boundary coordinate of each human being are identified in the initial image V1, and that of the two child human beings and two adult human beings are {(x1,y1), (x2,y2)}, {(x3,y3), (x4,y4)}, {(x5,y5), (x6,y6)}, and {(x7,y7), (x8,y8)}, in which a first maximum vertical ordinate value y5 and a first minimum horizontal ordinate value x5 are taken to define a human body collection upper boundary coordinate (Xmin, Ymax), and a first minimum vertical ordinate value y8 and a first maximum horizontal ordinate value x8 are taken to define a human body collection lower boundary coordinate (Xmax, Ymin). The human body collection upper boundary coordinate (Xmin, Ymax) and the human body collection lower boundary coordinate (Xmax, Ymin) are used to define a human body coverage area A1 for covering all the human beings, and define a first focal coordinate (x9,y9) of a center point C1 of the human body coverage area A1. The human body coverage area A1 approximately occupies 15% of the original size (2592×1944 pixels) of the initial image V1. Next, the step of calculating a cropping ratio 102 (process B) is performed.

Referring to the process B shown in FIG. 5 together, in the step of calculating a cropping ratio 102, the first focal coordinate (x9,y9) of the human body coverage area A1 is used as the center point, and the cropping frame A2 is enlarged according to the ratio parameter (as shown in FIG. 8B). That is, a ratio that the human body coverage area A1 is covered by the cropping frame A2 without exceeding is taken, so as to meet the covering ratio and according to the setting ratio range (40%-80%), a ratio that an area difference between the cropping frame A2 and the human body coverage area A1 is smallest is taken, so as to meet the difference ratio. In this embodiment, the cropping frame A2 is taken as 40% of the initial image V1 according to the ratio parameter, and the result of judging whether the cropping frame A2 exceeds the vertical boundary and/or horizontal boundary of the original size is no, and then the step of calculating a face coverage area 103 (process C) is performed. Referring to the process C shown in FIG. 6 together, and as shown in FIG. 9B, in the step of calculating a facial coverage area 103, a second upper boundary coordinate and a second lower boundary coordinate of a face of each human being are identified in the initial image V1, and that of the two child human beings and two adult human beings are {(x10,y10), (x11,y11)}, {(x12,y12), (x13,y13)}, {(x14,y14), (x15,y15)}, and {(x16,y16), (x17,y17)}, in which a second maximum vertical ordinate value y14 and a second minimum horizontal ordinate value x14 are taken to define a face collection upper boundary coordinate (Xmin, Ymax), and a second minimum vertical ordinate value y13 and a second maximum horizontal ordinate value x13 are taken to define a face collection lower boundary coordinate (Xmax, Ymin). The face collection upper boundary coordinate (Xmin, Ymax) and the face collection lower boundary coordinate (Xmax, Ymin) are used to define a facial coverage area A3 for covering the faces of all of the persons, and define a second focal coordinate (x18,y18) of a center point C2 of the facial coverage area A3 (as shown in FIG. 8C). Next, the step of alignment and cropping 104 (process D) is performed.

Referring to the process D shown in FIG. 7 together, in the step of alignment and cropping 104, a center point C3 of the cropping frame A2 is defined as a third focal coordinate (the same as the first focal coordinate (x9,y9)), the center point C3 of the cropping frame A2 is moved from the third focal coordinate (x9,y9) to the upper right to coincide with the second focal coordinate (x18,y18) (as shown in FIG. 8D). At this time, the center point C3 of the cropping frame A2 is changed to be concurrent with the center point C2, and it is judged whether the cropping frame A2 is covered within the initial image V1. If the judgment result that whether the cropping frame A2 exceeds the vertical and/or horizontal boundary of the original size of the initial image V1 is no, the range where the cropping frame A2 is located is selected to crop a cropped final image V2. The result is shown in FIG. 8E, the composition of the cropped final image V2 is centered on the faces of characters in the image, and the characters in the initial image V1 are recomposed according to the second aspect ratio (16:9) of the cropping frame A2, which ensures that the cropped final image V2 conforms to the composition effect of the characters as the main body compared to the initial image V1.

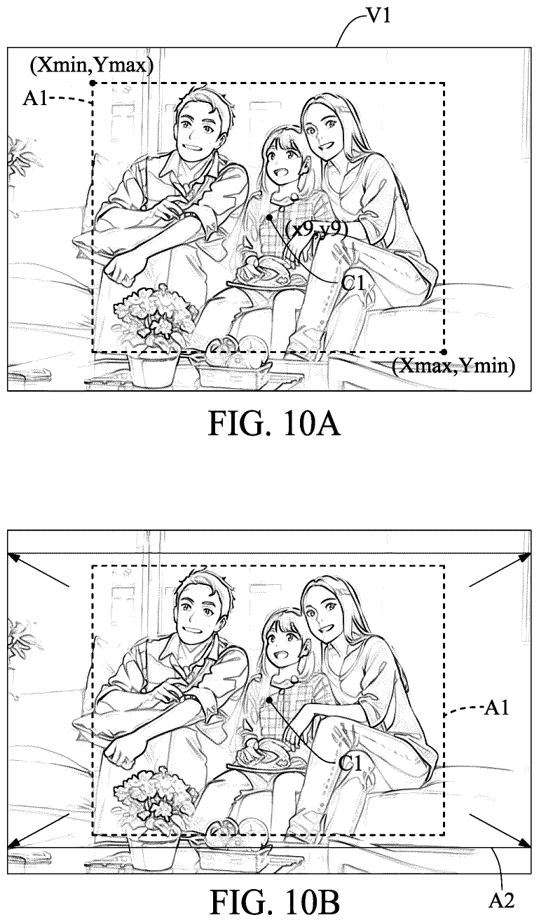

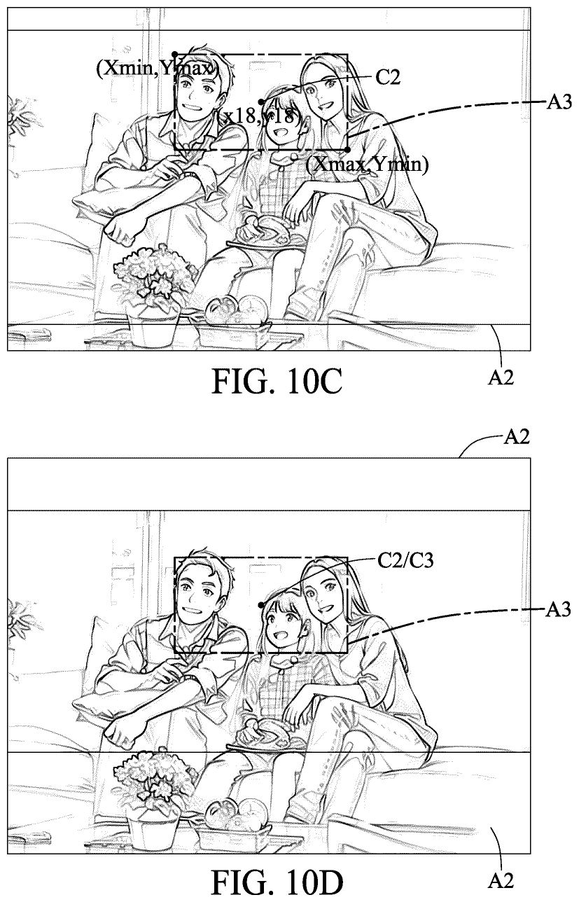

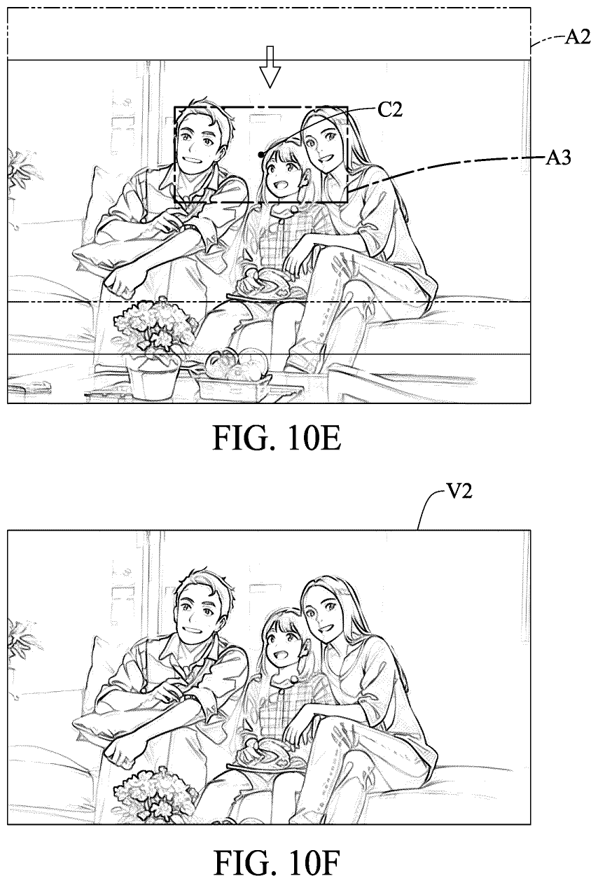

Further, another embodiment is shown as FIGS. 10A to 10F. The scene of the initial image V1 as shown in FIG. 10A includes one child human being and two adult human beings, wherein the adults and child are seated and located in the center of the initial image V1. Referring to the process A shown in FIG. 4 together, by executing the step of calculating a human body coverage area 101, there are the one child human being and two adult human beings identified by artificial intelligence. A first upper boundary coordinate and a first lower boundary coordinate of each human being are identified in the initial image V1, and then according to the process described in the embodiments described previously, a human body collection upper boundary coordinate (Xmin, Ymax) and a human body collection lower boundary coordinate (Xmax, Ymin) are obtained, the human body collection upper boundary coordinate (Xmin, Ymax) and the human body collection lower boundary coordinate (Xmax, Ymin) are used to define a human body coverage area A1 for covering all of the human beings, and define a first focal coordinate (x9,y9) of a center point C1 of the human body coverage area A1. The human body coverage area A1 of the present disclosure approximately occupies 71% of the original size (2592×1944 pixels) of the initial image V1. Next, the step of calculating a cropping ratio 102 (process B) is performed.

Referring to the process B shown in FIG. 5 together, in the step of calculating a cropping ratio 102, the first focal coordinate (x9,y9) of the human body coverage area A1 is used as the center point, and the cropping frame A2 is enlarged according to the ratio parameter (as shown in FIG. 10B). That is, a ratio that the human body coverage area A1 is covered by the cropping frame A2 without exceeding is taken, so as to meet the covering ratio. According to the setting ratio range (40%-80%), a ratio that an area difference between the cropping frame A2 and the human body coverage area A1 is smallest is taken, so as to meet the difference ratio. In an embodiment, the cropping frame A2 is taken as 80% of the initial image V1 according to the ratio parameter, and the result of judging whether the cropping frame A2 exceeds the vertical boundary and/or horizontal boundary of the original size is no, and then the step of calculating a facial coverage area 103 (process C) is performed.

Referring to the process C shown in FIG. 6 together, in the step of calculating a facial coverage area 103, a second upper boundary coordinate and a second lower boundary coordinate of a face of each human being are identified in the initial image V1. Then, according to the process described above, a face collection upper boundary coordinate (Xmin, Ymax) and a face collection lower boundary coordinate (Xmax, Ymin) shown as FIG. 10C are obtained, the face collection upper boundary coordinate (Xmin, Ymax) and the face collection lower boundary coordinate (Xmax, Ymin) are used to define a facial coverage area A3 for covering the faces of all the persons, and define a second focal coordinate (x18,y18) of a center point C2 of the facial coverage area A3 (as shown in FIG. 10C). Next, the step of alignment and cropping 104 (process D) is performed.

Referring to the process D shown in FIG. 7 together, in the step of alignment and cropping 104, a center point C3 of the cropping frame A2 is defined as a third focal coordinate (the same as the first focal coordinate (x9,y9)). The center point C3 of the cropping frame A2 is moved upward from the third focal coordinate (x9,y9) to coincide with the second focal coordinate (x18,y18) (as shown in FIG. 10D). At this time, the center point C3 of the cropping frame A2 is changed to be concurrent with the center point C2, and it is judged whether the cropping frame A2 is covered within the initial image V1. As a result, the cropping frame A2 exceeds the vertical boundary (upper boundary) of the original size of the initial image V1. At this time, the judgment result of whether the cropping frame A2 exceeds the vertical and/or horizontal boundary of the original size of the initial image V1 is yes, it is further executed that the cropping frame A2 shifts back according to the exceeded vertical boundary (shift downward to align the upper boundary shown as FIG. 10E), so that the cropping frame A2 is completely covered within the initial image V1. At this time, the range where the cropping frame A2 is located is selected to crop a cropped final image V2. The result is shown in FIG. 10F. The composition of the cropped final image V2 is centered on the position slightly below the faces of characters in the image, and the characters in the initial image V1 are recomposed according to the second aspect ratio (16:9) of the cropping frame A2, compared to the initial image V1, it can still obtain the composition effect that makes the cropped final image V2 closer to the characters as the main body than the initial image V1.

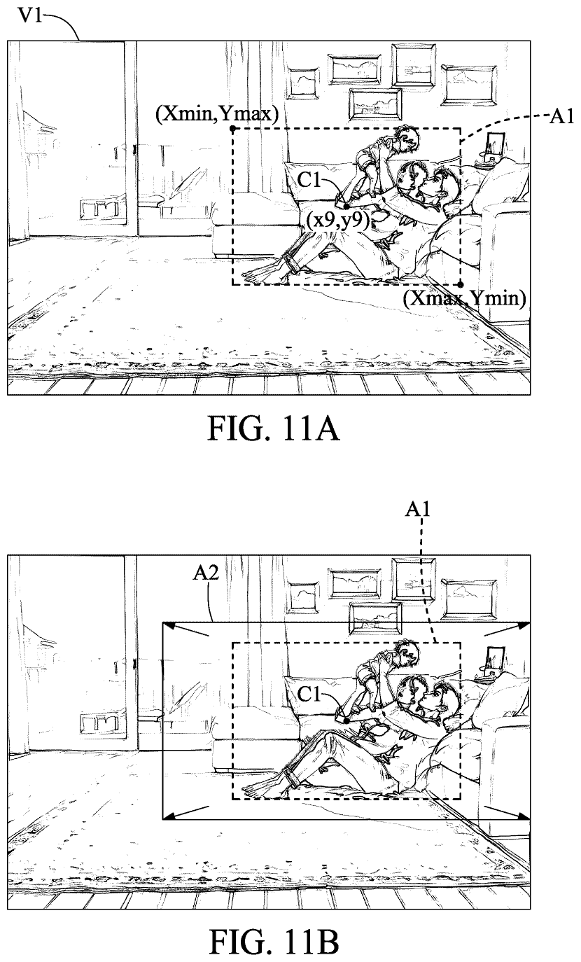

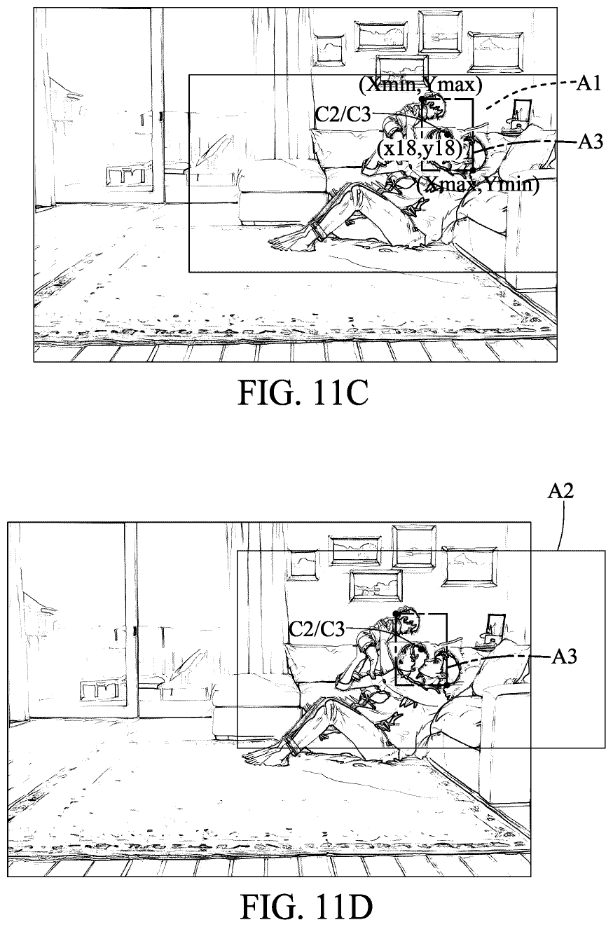

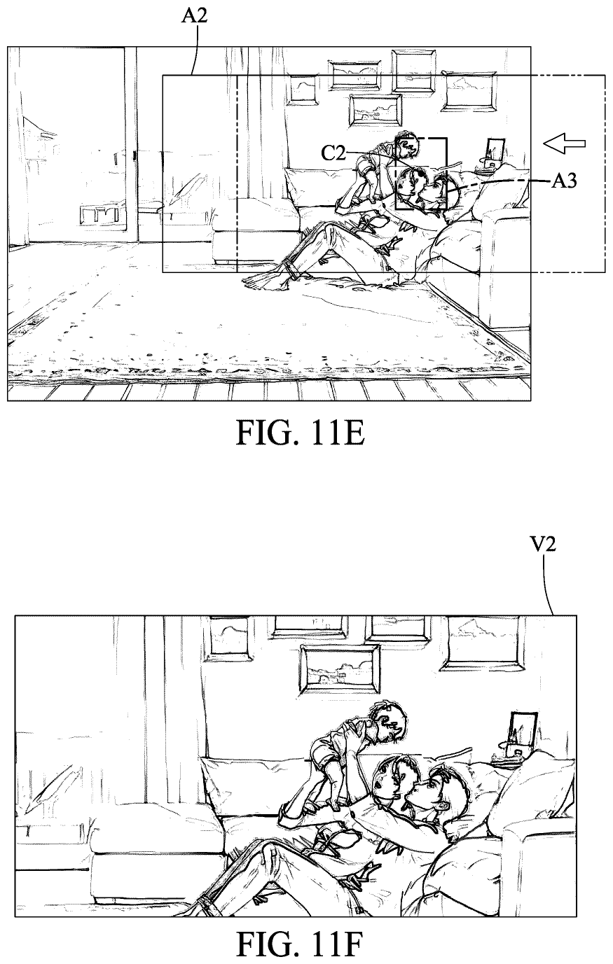

Further, an embodiment is shown as FIGS. 11A to 11F. The scene of the initial image V1 as shown in FIG. 11A includes one child human being and two adult human beings, wherein the adults and the child are seated and located on the right side of the initial image V1. Referring to the process A shown in FIG. 4 together, by executing the step of calculating a human body coverage area 101, there are the one child human being and two adult human beings identified by artificial intelligence. A first upper boundary coordinate and a first lower boundary coordinate of each human being are identified in the initial image V1. Then according to the process described above, a human body collection upper boundary coordinate (Xmin, Ymax) and a human body collection lower boundary coordinate (Xmax, Ymin) are obtained. The human body collection upper boundary coordinate (Xmin, Ymax) and the human body collection lower boundary coordinate (Xmax, Ymin) are used to define a human body coverage area A1 for covering all the human beings, and define a first focal coordinate (x9,y9) of a center point C1 of the human body coverage area A1. The human body coverage area A1 of the present disclosure approximately occupies 21% of the original size (2592×1944 pixels) of the initial image V1. Next, the step of calculating a cropping ratio 102 (process B) is performed.

Referring to the process B shown in FIG. 5 together, in the step of calculating a cropping ratio 102, the first focal coordinate (x9,y9) of the human body coverage area A1 is used as the center point, and the cropping frame A2 is enlarged according to the ratio parameter (as shown in FIG. 11B). That is, a ratio that the human body coverage area A1 is covered by the cropping frame A2 without exceeding is taken, so as to meet the covering ratio. According to the setting ratio range (40%-80%), a ratio that an area difference between the cropping frame A2 and the human body coverage area A1 is smallest is taken, so as to meet the difference ratio. In an embodiment, the cropping frame A2 is taken as 40% of the initial image V1 according to the ratio parameter. The result of judging whether the cropping frame A2 exceeds the vertical boundary and/or horizontal boundary of the original size is no, and then the step of calculating a facial coverage area 103 (process C) is performed.

Referring to the process C shown in FIG. 6 together, in the step of calculating a facial coverage area 103, a second upper boundary coordinate and a second lower boundary coordinate of a face of each human being are identified in the initial image V1. Then according to the process described above, a face collection upper boundary coordinate (Xmin, Ymax) and a face collection lower boundary coordinate (Xmax, Ymin) shown in FIG. 11C are obtained. The face collection upper boundary coordinate (Xmin, Ymax) and the face collection lower boundary coordinate (Xmax, Ymin) are used to define a facial coverage area A3 for covering the faces of all the persons, and define a second focal coordinate (x18,y18) of a center point C2 of the facial coverage area A3 (as shown in FIG. 11C). Next, the step of alignment and cropping 104 (process D) is performed.

Referring to the process D shown in FIG. 7 together, in the step of alignment and cropping 104, a center point C3 of the cropping frame A2 is defined as a third focal coordinate (the same as the first focal coordinate (x9,y9)), the center point C3 of the cropping frame A2 is moved from the third focal coordinate (x9,y9) to the upper right to coincide with the second focal coordinate (x18,y18) (as shown in FIG. 11D). At this time, the center point C3 of the cropping frame A2 is changed to be concurrent with the center point C2, and it is judged whether the cropping frame A2 is covered within the initial image V1. As a result, the cropping frame A2 exceeds the horizontal boundary (right boundary) of the original size of the initial image V1. At this time, the judgment result that whether the cropping frame A2 exceeds the vertical and/or horizontal boundary of the original size of the initial image V1 is yes, it is further executed that the cropping frame A2 shifts back according to the exceeded horizontal boundary (shift toward the left to align the right boundary shown as FIG. 11E), so that the cropping frame A2 is completely covered within the initial image V1. At this time, the range where the cropping frame A2 is located is selected to crop a cropped final image V2. The result is shown in FIG. 11F. The composition of the cropped final image V2 is centered on the position with a slight deviation to the right of the faces of characters in the image, and the characters in the initial image V1 are recomposed according to the second aspect ratio (16:9) of the cropping frame A2, compared to the initial image V1, it can still obtain the composition effect that makes the cropped final image V2 closer to the characters as the main body than the initial image V1.

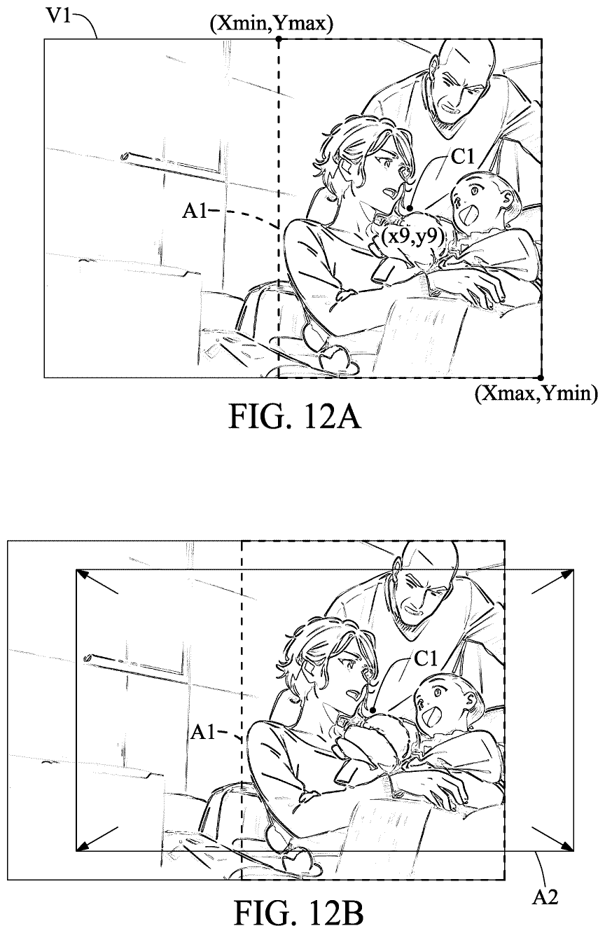

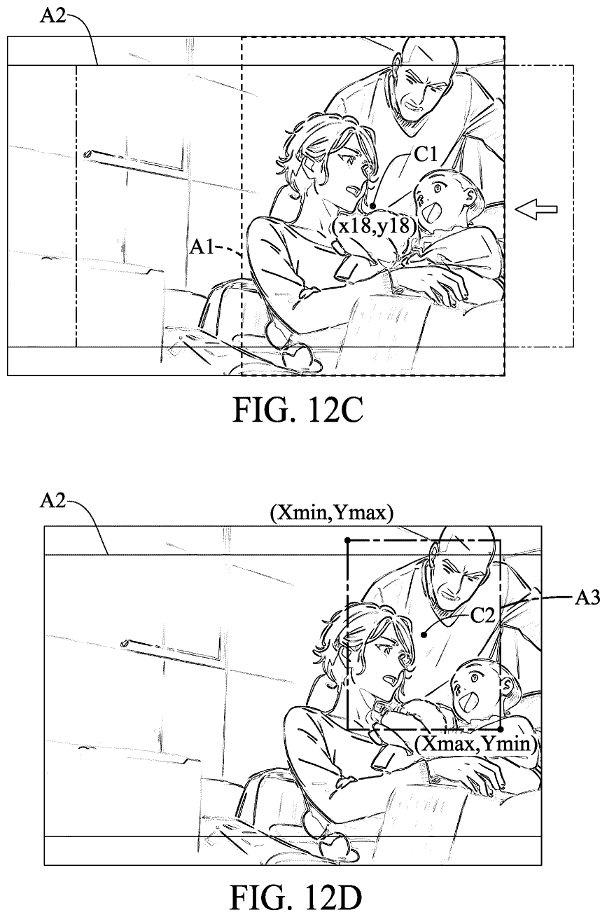

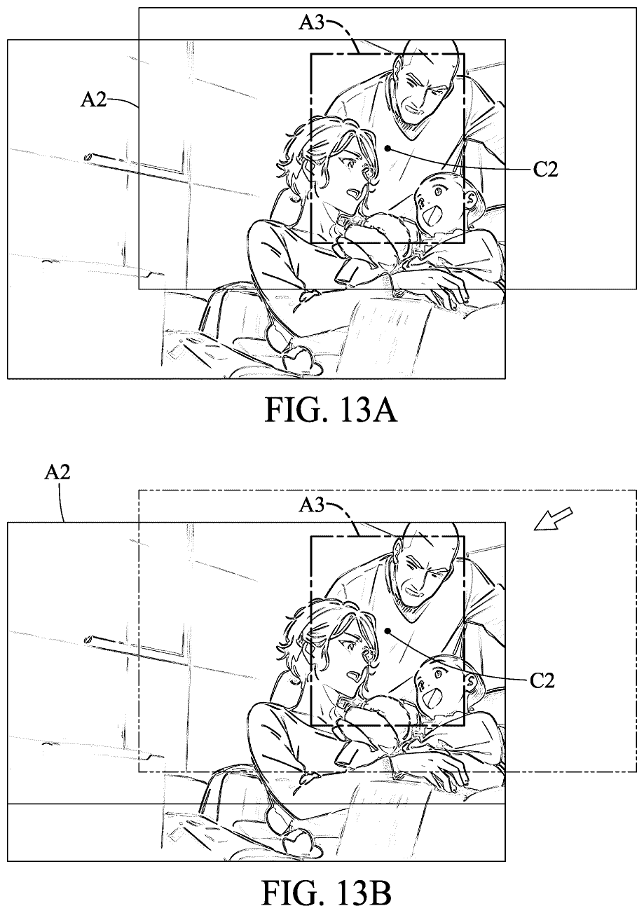

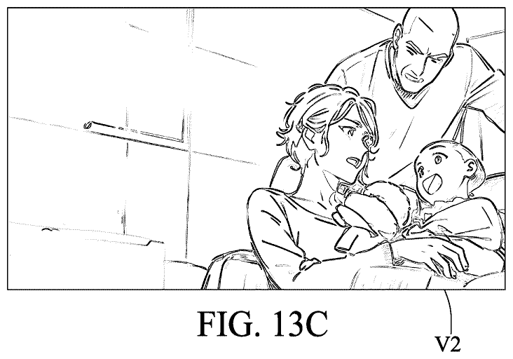

Further, another embodiment is shown in FIGS. 12A-13C. The scene of the initial image V1 as shown in FIG. 12A includes one child human being and two adult human beings, wherein the adults and child are seated and located on the right side of the initial image V1. Referring also to the process A shown in FIG. 4 at the same time, by executing the step of calculating a human body coverage area 101, there are the one child human being and two adult human beings identified by artificial intelligence. A first upper boundary coordinate and a first lower boundary coordinate of each human being are identified in the initial image V1. Then, according to the process described previously, a human body collection upper boundary coordinate (Xmin, Ymax) and a human body collection lower boundary coordinate (Xmax, Ymin) are obtained. The human body collection upper boundary coordinate (Xmin, Ymax) and the human body collection lower boundary coordinate (Xmax, Ymin) are used to define a human body coverage area A1 for covering all the human beings, and define a first focal coordinate (x9,y9) of a center point C1 of the human body coverage area A1. The human body coverage area A1 of the present disclosure approximately occupies 42% of the original size (2592×1944 pixels) of the initial image V1. Next, the step of calculating a cropping ratio 102 (process B) is performed.

Referring to the process B shown in FIG. 5 at the same time, in the step of calculating a cropping ratio 102, the first focal coordinate (x9,y9) of the human body coverage area A1 is used as the center point, and the cropping frame A2 is enlarged according to the ratio parameter (as shown in FIG. 12B). That is, a ratio that the human body coverage area A1 is covered by the cropping frame A2 without exceeding is taken, so as to meet the covering ratio. According to the setting ratio range (40%-80%), a ratio that an area difference between the cropping frame A2 and the human body coverage area A1 is smallest is taken, so as to meet the difference ratio. In an embodiment, the cropping frame A2 is taken as 50% of the initial image V1 according to the ratio parameter. As shown in FIG. 12B, the cropping frame A2 exceeds the horizontal boundary (exceeds the right boundary) of the original size. At this time, the result of judging whether the cropping frame A2 exceeds the vertical boundary and/or horizontal boundary of the original size is yes, it is further executed that the cropping frame A2 shifts back according to the exceeded horizontal boundary (shift toward the left to align the right boundary shown as FIG. 12C). The cropping frame A2 is completely covered within the initial image V1, and then the step of calculating a facial coverage area 103 (process C) is performed.

Referring to the process C shown in FIG. 6, in the step of calculating a facial coverage area 103, a second upper boundary coordinate and a second lower boundary coordinate of a face of each human being are identified in the initial image V1. Then, according to the process described previously, a face collection upper boundary coordinate (Xmin, Ymax) and a face collection lower boundary coordinate (Xmax, Ymin) shown as FIG. 12D are obtained. The face collection upper boundary coordinate (Xmin, Ymax) and the face collection lower boundary coordinate (Xmax, Ymin) are used to define a facial coverage area A3 for covering the faces of all the persons, and define a second focal coordinate (x18,y18) of a center point C2 of the facial coverage area A3 (as shown in FIG. 12D). Next, the step of alignment and cropping 104 (process D) is performed.

Refer to the process D shown in FIG. 7. In the step of alignment and cropping 104, a center point C3 of the cropping frame A2 is defined as a third focal coordinate (the same as the first focal coordinate (x9,y9)). The center point C3 of the cropping frame A2 is moved from the third focal coordinate (x9,y9) to coincide with the second focal coordinate (x18,y18) (as shown in FIG. 13A). At this time, the center point C3 of the cropping frame A2 is changed to be concurrent with the center point C2, and it is judged whether the cropping frame A2 is covered within the initial image V1. As a result, the cropping frame A2 exceeds the vertical boundary and horizontal boundary (exceeds the right boundary and upper boundary) of the original size of the initial image V1. At this time, the judgment result that whether the cropping frame A2 exceeds the vertical and/or horizontal boundary of the original size of the initial image V1 is yes, it is further executed that the cropping frame A2 shifts back according to the exceeded vertical boundary (shift toward the left and downwards to align the right boundary and the upper boundary as shown in FIG. 13B). As a result, the cropping frame A2 is completely covered within the initial image V1, at this time, the range where the cropping frame A2 is located is selected to crop a cropped final image V2. The result is shown in FIG. 13C, the composition of the cropped final image V2 is centered on the position with a slight deviation to the right of the faces of characters in the image. The characters in the initial image V1 are recomposed according to the second aspect ratio (16:9) of the cropping frame A2, compared to the initial image V1, it can still obtain the composition effect that makes the cropped final image V2 closer to the characters as the main body than the initial image V1.

The image cropping and processing method 100 and the electronic device 200 of the present disclosure define the human body coverage area A1 in the initial image V1 with the first aspect ratio, and use the focal coordinate of the human body coverage area A1 to define a cropping frame A2 enlarged according to the ratio parameter. Then, the focal coordinates of the cropping frame A2 and the facial coverage area A3 coincide to obtain the cropped final image V2. Since the cropping frame A2 covers the human body coverage area A1 and conforms to the second aspect ratio. The composition of the cropped final image V2 obtained is centered on the faces of characters in the image, and the characters in the initial image V1 are recomposed according to the second aspect ratio of the cropping frame A2 to ensure that the cropped final image V2 conforms to the composition effect of the characters as the main body, so that the proportion and position of the characters in the cropped final image V2 meet the expectations of users.

Further, when the step of calculating a cropping ratio 102 is executed, the first focal coordinate is used as the center point C1 to define the cropping frame A2. When the cropping frame A2 exceeds the vertical boundary and/or horizontal boundary of the original size of the initial image V1 and/or when executing the step of alignment and cropping 104 to make the focal coordinates of the cropping frame A2 and the facial coverage area A3 coincide, if the cropping frame A2 exceeds the vertical boundary and/or horizontal boundary of the original size of the initial image V1, the image cropping and processing method 100 and the electronic device 200 of the present disclosure may be executed to shift the cropping frame A2 back according to the exceeded vertical boundary and/or horizontal boundary. At this time, it can still obtain the composition effect that makes the cropped image closer to the characters as the main body than the initial image.

While the present invention has been described by means of preferable embodiments, those skilled in the art should understand the above description is merely embodiments of the invention, and it should not be considered to limit the scope of the invention. It should be noted that all changes and substitutions which come within the meaning and range of equivalency of the embodiments are intended to be embraced in the scope of the invention. Therefore, the scope of the invention is defined by the claims.

What is claimed is:

1. An image cropping and processing method for adjusting an aspect ratio, executed by an electronic device reading an executable code, when there is a human being identified in an initial image by artificial intelligence, cropping to the initial image from a first aspect ratio is executed to crop a cropped final image that meets a second aspect ratio, comprising the following steps:
calculating a human body coverage area: identifying coordinates of the human being in the initial image to define a human body coverage area, and defining a center point of the human body coverage area as a first focal coordinate;
calculating a cropping ratio: using the first focal coordinate as a center point to define a cropping frame, the cropping frame has the second aspect ratio, and the cropping frame corresponds to the human body coverage area and is enlarged according to a ratio parameter;
calculating a facial coverage area: identifying coordinates of a face of the human being in the initial image to define a facial coverage area, and defining a second focal coordinate of a center point of the facial coverage area; and
alignment and cropping: defining a center point of the cropping frame as a third focal coordinate, moving the center point of the cropping frame from the third focal coordinate to coincide with the second focal coordinate, and when it is judged that the cropping frame is covered within the initial image, an image of the cropping frame is selected as the cropped final image.

2. The image cropping and processing method for adjusting the aspect ratio according to claim 1, wherein the ratio parameter in the step of calculating a cropping ratio is determined by successively conforming to a covering ratio and a difference ratio, wherein the covering ratio is defined as when the center point of the cropping frame is moved from the third focal coordinate to coincide with the second focus coordinate, a ratio that the human body coverage area is covered by the cropping frame without exceeding is taken; the definition of the difference ratio is to take a ratio that an area difference between the human body coverage area and the cropping frame is smallest according to a setting ratio range.

3. The image cropping and processing method for adjusting the aspect ratio according to claim 2, wherein the ratio range is set between 40% and 80% of the original size of the initial image.

4. The image cropping and processing method for adjusting the aspect ratio according to claim 1, wherein in the step of calculating a cropping ratio, if the cropping frame exceeds a vertical boundary and/or horizontal boundary of the original size, the cropping frame shifts back according to the exceeded vertical boundary and/or horizontal boundary.

5. The image cropping and processing method for adjusting the aspect ratio according to claim 1, wherein in the step of alignment and cropping, if the center point of the cropping frame is moved from the third focal coordinate to coincide with the second focus coordinate, and the cropping frame exceeds the vertical boundary or horizontal boundary of the original size, the cropping frame shifts back according to the exceeded vertical boundary and/or horizontal boundary, so as to meet the condition that the cropping frame is covered within the initial image.

6. The image cropping and processing method for adjusting the aspect ratio according to claim 1, wherein when there are two or more human beings in the initial image, in the step of calculating a human body coverage area, a first upper boundary coordinate and a first lower boundary coordinate of each human being are identified, in which a first maximum vertical ordinate value and a first minimum horizontal ordinate value are taken to define a human body collection upper boundary coordinate, and a first minimum vertical ordinate value and a first maximum horizontal ordinate value are taken to define a human body collection lower boundary coordinate, the human body collection upper boundary coordinate and the human body collection lower boundary coordinate are used to define the human body coverage area.

7. The image cropping and processing method for adjusting the aspect ratio according to claim 6, wherein when there are two or more human beings in the initial image, in the step of calculating a facial coverage area, a second upper boundary coordinate and a second lower boundary coordinate of a face of each human being are identified, in which a second maximum vertical ordinate value and a second minimum horizontal ordinate value are taken to define a face collection upper boundary coordinate, and a second minimum vertical ordinate value and a second maximum horizontal ordinate value are taken to define a face collection lower boundary coordinate, the face collection upper boundary coordinate and the face collection lower boundary coordinate are used to define the facial coverage area.

8. A terminal device in communication with the electronic device executing the method according to claim 1, the terminal device is equipped with an application program, the terminal device executes the application program to display the cropped final image after executing the step of alignment and cropping.

9. An electronic device of image cropping and processing for adjusting an aspect ratio, provided in communication with a database, the database receives an initial image and identifies a human being by artificial intelligence, is used to execute cropping to the initial image from a first aspect ratio to crop a cropped final image that meets a second aspect ratio, the electronic device comprises:
a photography unit, for taking the initial image; and
a processing unit, electrically connected to the photography unit, the processing unit comprises:
a human body coverage area calculation module, for identifying coordinates of the human being in the initial image to define a human body coverage area, and defining a center point of the human body coverage area as a first focal coordinate;
a cropping ratio calculation module, electrically connected to the human body coverage area calculation module, using the first focal coordinate as a center point to define a cropping frame, the cropping frame has the second aspect ratio, and the cropping frame corresponds to the human body coverage area and is enlarged according to a ratio parameter;
a facial coverage area calculating module, for identifying coordinates of a face of the human being in the initial image to define a facial coverage area, and defining a second focal coordinate of a center point of the facial coverage area; and
an alignment and cropping module, electrically connected to the cropping ratio calculation module and the facial coverage area calculation module, for defining a center point of the cropping frame as a third focal coordinate, moving the cropping frame to the third focal coordinate to coincide with the second focal coordinate, and when it is judged that the cropping frame is covered within the initial image, an image of the cropping frame is selected as the cropped final image.

10. The electronic device according to claim 9, wherein the electronic device is a physical host and/or a cloud host.

11. A non-transitory computer-readable recording medium, storing a plurality of executable codes, after an electronic device reads the executable codes and executes, when there is a human being identified in an initial image by artificial intelligence, cropping to the initial image from a first aspect ratio is executed to crop a cropped final image that meets a second aspect ratio, comprising the following steps:
calculating a human body coverage area: identifying coordinates of the human being in the initial image to define a human body coverage area, and defining a center point of the human body coverage area as a first focal coordinate;
calculating a cropping ratio: using the first focal coordinate as a center point to define a cropping frame, the cropping frame has the second aspect ratio, and the cropping frame corresponds to the human body coverage area and is enlarged according to a ratio parameter;
calculating a face coverage area: identifying coordinates of a face of the human being in the initial image to define a facial coverage area, and defining a second focal coordinate of a center point of the facial coverage area; and
alignment and cropping: defining a center point of the cropping frame as a third focal coordinate, moving the center point of the cropping frame from the third focal coordinate to coincide with the second focal coordinate, and when it is judged that the cropping frame is covered within the initial image, an image of the cropping frame is selected as the cropped final image.
